(19) United States
(12) Patent Application Publication
(10) Pub. No.: US 2022/0177353 A1
(43) Pub. Date: Jun. 9, 2022

(54) BOROSILICATE GLASS ARTICLE

(71) Applicant: Schott AG, Mainz (DE)

(72) Inventors: Susanne Krüger, Mainz (DE); Oliver Hochrein, Mainz (DE); Malte Grimm, Mitterteich (DE); Rainer Erwin Eichholz, Frankfurt am Main (DE); Brigitte Woelzlein, Weidenbach (DE); Karin Naumann, Ober-Olm (DE)

(73) Assignee: Schott AG, Mainz (DE)

(21) Appl. No.: 17/542,005

(22) Filed: Dec. 3, 2021

(30) Foreign Application Priority Data
Dec. 3, 2020 (EP) 20211681.0

(51) Int. Cl. C03C 3/118; C03C 4/00; C03C 21/00; C03B 27/00

(52) U.S. Cl. CPC C03C 3/118; C03C 4/0085; H01J 61/302; C03B 27/00; C03C 2204/00; C03C 21/002

(57) ABSTRACT

A glass article is composed of a glass having a demixing factor in respect of its hydrolytic resistance in a range from 0.10 to 1.65.

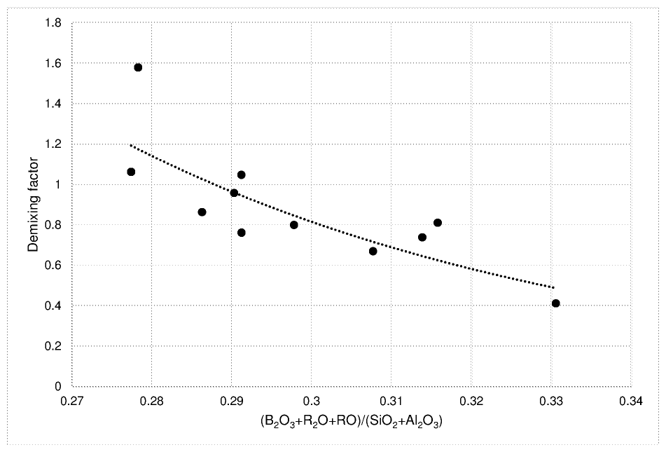

### CROSS REFERENCE TO RELATED APPLICATIONS

This application claims priority to European Patent Application No. EP 20211681.0 filed on Dec. 3, 2020, which is incorporated in its entirety herein by reference.

### BACKGROUND OF THE INVENTION

### 1. Field of the Invention

The invention relates to articles composed of borosilicate glass having a high UV transmission, advantageous properties in respect of demixing and good joining properties on fusion. The invention also relates to the use of this glass, in particular in UV lamps and photomultipliers.

### 2. Description of the Related Art

Apart from fused silicas, alkali metal borosilicate glasses which likewise have a high UV transmission and are more easily fusible are also known from the prior art. Disadvantages compared to fused silica are that these glasses which have a high boron content have a strong tendency to undergo demixing. Demixing means that an alkali metal borate or alkaline earth metal borate is formed in addition to a silicate glass phase in the glass. This can lead not only to lump formation caused by evaporation during production but also to a reduction in the transmission in the UV range. Furthermore, demixing leads to a deterioration in the hydrolytic resistance of the glasses.

A reduction in the boron oxide content has therefore been considered in the prior art in order to counter these problems. However, to ensure a similar fusibility despite a reduced boron content, the proportion of alkali metals and alkaline earth metals has to be increased, which presents problems in respect of the desired UV transmission. A glass for the envisaged applications should have good joining properties both in respect of metallic materials and in respect of other UV transparent glasses.

DE 10 2009 036 063 B3 describes glasses having a reduced boron oxide content compared to earlier glasses but nevertheless with high UV transmission. This was achieved by increasing the content of SiO₂, Li₂O, K₂O and BaO. Lithium oxide and potassium oxide are known in the literature for leading, in contrast to sodium oxide, to a shift in the UV edge to lower wavelengths. However, lithium oxide tends to vaporize and also increases the price of the mix. Increasing the potassium oxide content, on the other hand, leads, due to the radiation of its isotope ⁴⁰K, to a glass which is unsuitable for use in photomultipliers.

DE 43 38 128 C1 describes glasses having a low boron oxide content and a very high silicon dioxide content. This increases the processing temperatures and leads to a very low coefficient of thermal expansion (<3.5 ppm/K).

JP 2015-193521 A likewise discloses glass compositions having a very low boron oxide content. However, the increase in the alkalis, in particular sodium oxide, leads to a decrease in the UV transmission, especially at 200 nm (<30%). Furthermore, the increase in the sodium oxide content leads to a coefficient of thermal expansion (>5 ppm/K) which on fusion of the glass to other UV-transparent glasses presumably results in a high fusion stress.

JP 2018-131384 A and JP 2018-131385 A describe glasses having a low boron oxide content but a reduced transmission in the UV range (<30% at 200 nm for a 0.7 mm thick specimen) and an increased coefficient of thermal expansion (>6.5 ppm/K) due to a high sodium oxide content.

The glasses having a low boron oxide content which are described in U.S. Pat. No. 7,358,206 B2 comprise so much potassium oxide (>7.5 mol %) that use in photomultipliers is made considerably more difficult. In these glasses, the proportion of fluorine leads to the good UV transmission (50% for a 1 mm thick specimen) at ≤200 nm but also to an increased tendency to undergo demixing and a reduced hydrolytic resistance. Decreasing the boron oxide content at a low aluminium oxide content results in a reduction in the UV transmission (<80% at 254 nm for a 0.5 mm thick specimen). This is made clear in US 2018/0057393 A1, especially in Examples 17, 26 and 41. Furthermore, it can clearly be seen how the coefficient of thermal expansion increases when too much sodium oxide is used.

The glasses in JP S60-200842 A display a low UV transmission (≤80% @ 350 nm, i.e. the transmission at lower wavelengths is even less) due to a reduced boron oxide content and a high alkali metal content.

JP S60-021830 A describes glasses having a relatively high boron oxide and aluminium oxide content but also a very high alkali metal content. It is clear from the examples that this leads to high coefficients of thermal expansion (≥5 ppm/K). The high alkali metal contents result predominantly in transmissions of <80% at 253.7 nm for a 1 mm thick specimen.

U.S. Pat. No. 5,277,946 A describes glasses having a very low boron oxide content; these are aluminoborosilicate glasses rather than borosilicate glasses. They have a very good UV transmission (>80% at 253.7 nm for a 1 mm thick specimen) but due to a high sodium oxide content display a high coefficient of thermal expansion (>5 ppm/K).

CN 104591539 A demonstrates that a high UV transmission (>40% at 190 nm and >80% at 254 nm for a 1 mm thick specimen) can be achieved when high boron oxide contents but rather low aluminium oxide contents are used in the glasses and are compensated by alkali metals. However, the use of exclusively alkali metals leads to high coefficients of thermal expansion. Furthermore, such glass compositions do not display good hydrolytic resistance.

US 2018/0339932 A1 describes aluminoborosilicate glasses having a very low boron oxide content but a high proportion of aluminium oxide and alkaline earth metal oxides. This results in a very low coefficient of thermal expansion (<3.5 ppm/K).

What is needed in the art is a way to provide glasses which have a high UV transmission and are readily fusible. The glasses should also have good demixing behaviour and good hydrolytic resistance. Furthermore, the glasses should have a low fusion stress both with metallic materials and with other UV transparent glasses.

### SUMMARY OF THE INVENTION

In some exemplary embodiments provided according to the invention, a glass article is composed of a glass having a demixing factor in respect of its hydrolytic resistance in a range from 0.10 to 1.65.

In some exemplary embodiments provided according to the invention, a UV lamp includes a glass article composed of a glass having a demixing factor in respect of its hydrolytic resistance in a range from 0.10 to 1.65.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawing, wherein:

the sole FIGURE illustrates a graph of value pairs for illustrative glasses with the demixing factor on the ordinate and the ratio of the sum of the contents (in mol %) of B₂O₃, R₂O and RO to the sum of the contents (in mol %) of SiO₂ and Al₂O₃ on the abscissa.

The exemplification set out herein illustrates one embodiment of the invention and such exemplification is not to be construed as limiting the scope of the invention in any manner.

### DETAILED DESCRIPTION OF THE INVENTION

The invention relates to a glass which is resistant in a number of respects and glass articles consisting thereof. It has a high hydrolytic resistance which barely changes even after fusion to a join partner. In addition, the glass retains its high transmission even after irradiation with UV radiation over a prolonged period of time. The glass also has only a low tendency to undergo demixing.

In some embodiments, the invention provides a glass article composed of a glass having a demixing factor in respect of its hydrolytic resistance in the range from 0.1 to 1.65, or from 0.2 to 1.65, or from 0.35 to 1.65, for example from 0.7 to 1.10. In some embodiments, the demixing factor is at least 0.1, or at least 0.2, or at least 0.35, or at least 0.40 or at least 0.70.

The demixing factor is a measure of the tendency of the glass to change its hydrolytic resistance in accordance with ISO 719 as a result of demixing. Demixing occurs to a certain extent on fusion of the glasses because of the temperature influence. Glasses having a demixing factor of very close to 1 have the advantage that their hydrolytic resistance after demixing barely differs from that of the glass which has not demixed. The demixing factor is influenced by the composition of the glass and also by its thermal history (cool state). The demixing factor in respect of the hydrolytic resistance is optionally from 0.40 to 1.65 or at least 0.65. In some embodiments, the demixing factor is up to 1.4, up to 1.25 or up to 1.10.

In some embodiments, the demixing factor is at least 0.70 and up to 1.6. In some embodiments, the demixing factor is at least 0.3 and up to 0.5.

In some embodiments, the invention provides a glass article composed of a glass having a molar ratio in mol % of B₂O₃ to BaO of at least 8 and not more than 20, for example at least 10 and not more than 15. Glasses having the abovementioned ratio of proportions display good properties in respect of the hydrolytic resistance and the demixing factor and they have only a small induced extinction, which has many advantages particularly when used as UV-transparent material.

In some embodiments, the invention provides a glass article composed of a glass having an R₂O content of not more than 7 mol %, a transmission of at least 83% at 254 nm (measured at a specimen thickness of 1 mm) and of at least 40% at 200 nm (measured at a specimen thickness of 1 mm), wherein the glass article has a fusion stress with a metal or a metal alloy having a coefficient of thermal expansion of 5.4 ppm/K in the range from −400 to −130 nm/cm and/or with a glass having a coefficient of thermal expansion of 5.0 ppm/K in the range from >0 to 300 nm/cm.

The glass articles can be used for fusion to a further join partner. Here, the join partners are heated to a fusion temperature and joined to one another. During subsequent cooling, the parts which have been joined to one another display a different degree of shrinkage. It is astonishing that only a comparatively low stress is observed on joining to a metal or a metal alloy when using the glass articles provided according to the invention even though the CTE of the metal is significantly greater than that of the glass article. It is also highly astonishing that a comparatively low stress is obtained on fusion with glass. It has been found that the fusion stress should, in some embodiments, not drop below −400 nm/cm. If the absolute value of the fusion stress becomes too great, large stresses are built up in the fused article and rupture of the bond can occur.

In some embodiments, the invention provides a glass article composed of a glass having an induced extinction α(λ) after 48 hours irradiation with a deuterium lamp at 200 nm of not more than 0.300. The induced extinction indicates the extent to which the extinction and thus the transmission of a glass is altered by irradiation. The transmission is typically decreased by UV radiation (induced extinction is positive). This is also referred to as “solarization”. Too great an induced extinction leads to a short useful life of the glass article or to a rapidly decreasing transmission under irradiation.

In some embodiments, the invention provides a glass article composed of a glass having a ratio of the sum of the contents (in mol %) of B₂O₃, R₂O and RO to the sum of the contents (in mol %) of SiO₂ and Al₂O₃ of at least 0.1 and not more than 0.4. Glasses having the ratio of proportions indicated display good properties in respect of the hydrolytic resistance and the demixing factor and they have only a low induced extinction, which has many advantages particularly when used as UV-transparent material.

For the purposes of the invention, “R₂O” refers to the alkali metal oxides Li₂O, Na₂O and K₂O. “RO” refers to the alkaline earth metal oxides MgO, CaO, BaO and SrO.

The “coefficient of thermal expansion” or “CTE” is the average coefficient of linear thermal expansion in a temperature range from 20° C. to 300° C. It is determined in accordance with DIN ISO 7991:1987.

The “demixing factor in respect of the hydrolytic resistance” is calculated as follows:

$$E \text{-} Factor = \frac{{Equ}_{raw}}{{Equ}_{dem}}$$

Here, Equ_{raw} and Equ_{dem} are the extracted Na₂O equivalent in μg per g of glass for the raw, i.e. not demixed, glass and for the demixed glass, respectively. The extracted Na₂O equivalent is determined in accordance with ISO 719:1989-12. The demixing factor is a property of the glass. Reporting of this factor does not mean that the glass is demixed, but instead that in the case of demixing the altered hydrolytic resistance in the test in accordance with ISO 719 is within a particular window. Any glass can be examined in respect of its demixing factor. For this purpose, the extracted Na₂O equivalent is determined in accordance with ISO 719 on the glass which has not demixed (Equ_{raw}). The same measurement is carried out on a demixed glass (Equ_{dem}). A “demixed glass” is a glass which has been maintained at 100° C. above the glass transition temperature T_{g} for 4 hours. A certain degree of demixing occurs during this heat treatment.

“Fusion stress” is the stress (tensile or compressive stress) which is established at the joining interface between two fused components at room temperature. A negative sign means a compressive stress, while a positive sign means a tensile stress. The fusion stress can be determined in accordance with DIN 52327:1977-11, with part 1 of the standard being applicable for the fusion stress of glass with glass and part 2 being applicable for that of glass with metal or metal alloy. In the present description, the fusion stress will also, inter alia, be reported in the form of the stress-induced double refraction Δn, which is given by the ratio of the optical path length difference Δs to the specimen thickness d, in nm/cm. This stress-induced double refraction is proportional to the actual fusion stress which in the vicinity of the fusion interface (e.g. at a distance of 0.5 mm) can be calculated according to the following equation:

$$σ = \frac{Δ s}{d \cdot K} = \frac{Δ n}{K}$$

Here, σ is the actual fused stress and K is the stress-induced optical coefficient. When a fusion stress of an article having a join partner composed of glass is reported in nm/cm in the present description for the glass article, this is the stress-induced double refraction in the join partner (e.g. within a distance of 0.5 mm from the join interface).

“T₄” is the temperature at which the glass has a viscosity of 10⁴ dPa s. T₄ can be measured by methods known to a person skilled in the art for determining the viscosity of glass, e.g. in accordance with DIN ISO 7884-1:1998-02. “T₁₃” is the temperature at which the glass has a viscosity of 10¹³ dPa s.

The “reference refractive index” is the refractive index assumed by a glass when it has been cooled particularly slowly. It then has a particularly dense structure. When a glass is cooled quickly, it has a refractive index which is lower than the reference refractive index. The reference refractive index is determined by reheating the glass after production thereof to a temperature which corresponds to 0.85*T₁₃ (in K), holding there for 22 hours and then cooling at a cooling rate of 2 K/h to a temperature of 20° C. The refractive index (=reference refractive index) is then measured and the difference from the refractive index before this renewed cooling is determined. In some embodiments, T₁₃ of the borosilicate glass is less than 550° C.

Solarization” is the reduction in the transmission for light of different wavelength ranges caused by the action of short-wavelength UV light. Solarization can make the glass coloured or completely opaque.

The “solarization resistance” is the ability of the glass to retain a high transmission at a particular wavelength even after UV irradiation. It can be described by calculation of the induced extinction α(λ)

$$α ( λ ) = - ln \frac{{T ( λ )}_{1}}{{T ( λ )}_{0}}$$

where T(λ)₀=transmission before irradiation and T(λ)ᵢ=transmission after irradiation for i hours with a deuterium lamp. The smaller α(λ), the more resistant is the glass against solarization. The solarization resistance is here reported for the wavelengths 200 nm and 254 nm since these wavelengths are of particular significance for the use of the glass article. In the present description, a specimen thickness of from about 0.70 mm to 0.75 mm is assumed for reporting of the solarization resistance. This means that the measurement takes place at this specimen thickness. The glass article itself can have a different thickness. Irradiation is carried out using a deuterium lamp. Deuterium lamps emit light down to a very short-wavelength UV range. The lamp used here has a limiting wavelength of 115 nm. The power of the deuterium lamp can be about 1 W/m². The following deuterium lamp can be used: Heraeus Noblelight GmbH, Type V04, Series No.: V0390 30 W, with MgF₂ filter for sufficient emission to 115 nm.

The “hydrolytic class” is determined in accordance with ISO 719:1989-12. It is a measure of the extractability of the basic compounds from the glass in water at 98° C. The result of the measurement is the extracted Na₂O equivalent in μg per g of glass. Up to 31 μg/g, conformity is to the class HGB1, up to 62 μg/g the class HGB2 and up to 264 μg/g the class HGB3.

The features and advantageous properties described further herein apply equally to the previously described aspects of the invention. The glass or borosilicate glass described herein is the glass of which the glass article consists. The glass article can be a rod, ingot, powder, a pane, plate or a tube.

The thickness of the article, in particular the wall thickness in the case of a tube, can be at least 0.1 mm or at least 0.3 mm. The thickness can be limited to up to 3 mm or up to 2 mm. The external diameter of the glass article, e.g. the external diameter of a tube or rod, can be up to 50 mm, up to 40 mm or up to 30 mm. The external diameter can, in particular, be at least 1 mm, at least 2 mm or at least 3 mm. In some embodiments, the article has a thickness that is at least 3 mm and/or at most 20 mm. Optionally, the thickness is at least 5 mm, at least 6 mm, or at least 8 mm. The thickness may be limited to a maximum of 20 mm, up to 16 mm, up to 14 mm, or up to 12 mm. In some embodiments, the article has a length and a width, in particular the length being greater than the width. The length may be at least 20 mm, at least 40 mm or at least 60 mm. Optionally, it is at most 1000 mm, at most 600 mm, at most 250 mm or at most 120 mm. In some embodiments, the length is from 20 mm to 1000 mm, from 40 mm to 600 mm, or from 60 mm to 250 mm. The width may be at least 10 mm, at least 25 mm, or at least 35 mm. Optionally, the width is at most 575 mm, at most 225 mm or at most 110 mm. In some embodiments, the width is from 10 mm to 575 mm, from 25 mm to 225 mm, or from 35 mm to 110 mm.

It has been found that a glass having a refractive index of at least 0.0001 below its reference refractive index, and thus also having a density below its reference density, can have a lower fusion stress than the same glass having a higher density. It is presumed that such a glass shrinks more greatly after fusion to a join partner composed of metal or glass due to its higher hypothetical temperature than a glass which has a lower hypothetical temperature. The usual join partners have coefficients of thermal expansion which are more than 4.5 ppm/K, so that they shrink more strongly after fusion than the glass article of the invention. This would give a high stress at the join interface.

In some embodiments, the borosilicate glass has a cool state which corresponds to a cooling rate of significantly more than 2 K/h. The borosilicate glass can be cooled so quickly that it has a comparatively high hypothetical temperature. A high hypothetical temperature is associated with a density which is lower than a reference density of the same glass composition. The borosilicate glass can have a density of less than 2.5 g/cm³. The density correlates with the refractive index, so that measurement of a density change of the article can be carried out by measuring the change in the refractive index. At the reference density, the glass has its reference refractive index. In some embodiments, the borosilicate glass has a refractive index n_{d} of from 1.45 to 1.55. According to the invention, preference may be given to a borosilicate glass having a refractive index which is reduced by at least 0.0001 compared to its reference refractive index. The refractive index of the glass may be even at least 0.0004, such as at least 0.0006, less than the reference refractive index of the glass. However, the thermal shrinkage caused by the higher hypothetical temperature after fusion should not be too great since otherwise excessively high stresses can occur at the join interface. Thus, the reduction in the refractive index compared to the reference refractive index can be limited to a maximum of 0.1, for example a maximum of 0.01 or a maximum of 0.001.

The thermal shrinkage can be less than 50 μm/100 mm for the glass provided according to the invention. In some embodiments, the thermal shrinkage is less than 30 μm/100 mm or less than 20 μm/100 mm. The thermal shrinkage can be at least 1 μm/100 mm or at least 5 μm/100 mm. Although an extremely low thermal shrinkage can also be achieved, the very slow cooling necessary for this is uneconomical. The thermal shrinkage of the glass can be measured by maintaining a previously precisely measured glass article at a temperature of 0.85*T₁₃ (in K) for 22 hours, then cooling it at a cooling rate of 2 K/h to 20° C. and subsequently measuring it again. Comparison of the dimension of the glass article before and after the heat treatment gives the thermal shrinkage. Preference may be given to measuring the dimension along the longitudinal extension of the glass article, e.g. along the longitudinal axis. For example, it is possible to use a test specimen having an edge length of a square cross section of 5.8 mm and a length of 100 mm.

The glass and/or the glass article may have a transmission of at least 50%, at least 70%, at least 80% or at least 83%, at a wavelength of 254 nm. This transmission may be advantageous for use of the glass article in a UV lamp. The greater the transmission in the UV, the more efficient the lamp. In some embodiments, the transmission at 254 nm is not more than 99.9%, not more than 95% or not more than 90%. The transmission is, in particular, measured at a specimen thickness of 1 mm. This does not necessarily mean that the glass article has a thickness of 1 mm, but instead means that the transmission is measured at this thickness. The transmission values indicated may also apply after irradiation with a deuterium lamp for a time of 48 hours and/or 96 hours. The following deuterium lamp can be used: Heraeus Noblelight GmbH, Type V04, Series No.: V0390 30 W, with MgF₂ filter for sufficient emission to 115 nm.

The glass and/or the glass article may have a transmission of at least 40%, at least 50%, at least 55% or at least 60%, at a wavelength of 200 nm. This transmission may be, for example, advantageous for use of the glass article in a UV lamp. The greater the transmission in the UV, the more efficient the lamp. In some embodiments, the transmission at 200 nm is not more than 95%, not more than 85% or not more than 70%. The transmission is, in particular, measured at a specimen thickness of 1 mm. This does not necessarily mean that the glass article has a thickness of 1 mm, but rather means that the transmission is measured at this thickness. The transmission values indicated may also apply after irradiation with a deuterium lamp for a time of 48 hours and/or 96 hours. It is possible to use, for example, the deuterium lamp which has been mentioned previously.

For many applications, a very uniform transmission in the UV range is desirable. The glasses provided according to the invention have a ratio of the transmission at 254 nm to the transmission at 200 nm (in each case measured at a specimen thickness of 1 mm) of at least 1.00 and not more than 2.00, in particular not more than 1.65 or not more than 1.50.

The glass may have an induced extinction α(λ) of not more than 0.300 at 200 nm after irradiation with a deuterium lamp for 48 hours. The induced extinction is a measure of the solarization tendency of a glass. The greater the induced extinction of a glass, the more greatly does the transmission decrease as a result of UV irradiation. A high UV transparency is important for the glasses provided according to the invention. An exemplary low induced extinction at 200 nm after irradiation with a deuterium lamp for 48 hours is not more than 0.300, not more than 0.200 or not more than 0.100, for example not more than 0.05. This maximum induced extinction may not be exceeded even after irradiation with a deuterium lamp for 96 hours.

The induced extinction should also be low at longer wavelengths in the UV range. In some embodiments, the induced extinction at 254 nm after irradiation with a deuterium lamp for 48 hours is not more than 0.100, for example not more than 0.01. This value is, in some embodiments, also not exceeded after irradiation with a deuterium lamp for 96 hours. However, a certain induced extinction at 254 nm or at 200 nm can also occur in the case of the glasses provided according to the invention, e.g. from 0.0001 or from 0.001, after irradiation with a deuterium lamp for 48 hours or 96 hours.

The glass article is particularly suitable for fusion with metals, metal alloys and glasses. In particular, the glass article can be used for fusion with materials which have a higher coefficient of thermal expansion than the glass article, e.g. a CTE of >4.6 ppm/K, or >4.9 ppm/K. The glass article can have a fusion stress against a metal or a metal alloy having a coefficient of thermal expansion of 5.4 ppm/K of more than −500 nm/cm, in particular more than −400 nm/cm or more than −300 nm/cm. In some embodiments, the fusion stress is not more than 0 nm/cm or not more than −130 nm/cm. Here, “more than” means that a negative value has become less negative. “More than −500 nm/cm” thus encompasses, for example, −490 nm/cm.

The glass article can have a fusion stress against a glass having a coefficient of thermal expansion of 5.0 ppm/K of less than 300 nm/cm, in particular less than 250 nm/cm or less than 180 nm/cm. In some embodiments, this fusion stress is less than 0 nm/cm or less than 90 nm/cm. It may be advantageous to keep the fusion stress within limits so that better joins are obtained. In principle, a compressive stress (negative sign) may be preferred over a tensile stress (positive sign) so that the glass is not damaged. When it is stated herein that the glass article has a particular fusion stress, this means that the glass article would have this property in the event of it being fused. It does not mean that the join partner is part of the glass article.

The glass may be a borosilicate glass. In some embodiments, the borosilicate glass comprises the following components (in mol % on an oxide basis):

| Component | Content (mol %) |
|---|---|
| SiO₂ | 60-78 |
| Al₂O₃ | 0-10 |
| B₂O₃ | 12-24 |
| Li₂O | 0 to 3.0 |
| Na₂O | 0-6 |
| K₂O | 0-4 |
| MgO | 0-6 |
| CaO | 0-6 |
| SrO | 0-4 |
| BaO | 0-4 |
| F⁻ | 0-6 |
| Cl⁻ | 0-0.5 |
| R₂O | 3.5-10 |
| RO | 0-6 |

The glasses provided according to the invention can comprise SiO₂ in a proportion of at least 60 mol %. SiO₂ contributes to the hydrolytic resistance and transparency of the glass. At an excessively high content of SiO₂, the melting point of the glass is too high. The temperatures T₄ and T_{g} then also increase greatly. For this reason, the content of SiO₂ has to be limited to not more than 78 mol %. The content of SiO₂ may be at least 61 mol %, at least 63 mol % or at least 65 mol %. In some embodiments, the content can be restricted to not more than 75 mol % or not more than 72 mol %.

The glasses provided according to the invention contain Al₂O₃ in a proportion of not more than 10 mol %. Al₂O₃ contributes to the demixing stability of the glasses, but in larger proportions reduces the acid resistance. In addition, Al₂O₃ increases the melting point and T₄. The content of this component can thus be limited to a maximum of 9 mol % or a maximum of 8 mol %. In some embodiments, Al₂O₃ is used in a small proportion of at least 2 mol %, at least 2.5 mol % or at least 3 mol % or at least 3.5 mol %.

The glasses provided according to the invention can contain B₂O₃ in a proportion of at least 12 mol %. B₂O₃ has an advantageous effect on the melting properties of the glass: in particular, the melting point is reduced and the glass can be fused to other materials at lower temperatures. However, the proportion of B₂O₃ should not be too high since the glasses otherwise have a strong tendency to demix. Furthermore, too much B₂O₃ has adverse effects on the hydrolytic resistance and the glass tends to suffer from high evaporation losses during production and thus to a lumpy glass. It can be restricted to up to 24 mol %, up to 22 mol % or up to 20 mol %. In some embodiments, the content of B₂O₃ is not more than 17 mol %. The content of B₂O₃ can be at least 12 mol % or at least 14 mol %.

In some embodiments, the ratio of the sum of the contents (in mol %) of B₂O₃, R₂O and RO to the sum of the contents (in mol %) of SiO₂ and Al₂O₃ is not more than 0.4, in particular not more than 0.35, for example not more than 0.33. In some embodiments, this value is at least 0.1, such as at least 0.2 or at least 0.26. Glasses having the specified ratio of proportions display good properties in respect of the hydrolytic resistance and the demixing factor and have only a low induced extinction, which has many advantages when used, in particular, as UV-transparent material.

The glasses provided according to the invention can contain Li₂O in a proportion of up to 3.0 mol %, up to 2.8 mol % or up to 2.5 mol %. Li₂O increases the fusibility of the glasses and results in an advantageous shift of the UV edge to shorter wavelengths. However, lithium oxide has a tendency to vaporize, increases the demixing tendency and also increases the price of the mix. In some embodiments, the glass contains only little Li₂O, e.g. not more than 3.0 mol %, not more than 2.0 mol % or not more than 1.9 mol %, or the glass is free of Li₂O.

The glasses provided according to the invention contain Na₂O in a proportion of up to 6 mol %. Na₂O increases the fusibility of the glasses. However, sodium oxide also leads to a reduction in the UV transmission and to an increase in the coefficient of thermal expansion. The glass can comprise Na₂O in a proportion of at least 1 mol % or at least 2 mol %. In one embodiment, the content of Na₂O is not more than 5 mol % or not more than 4 mol %.

The glasses provided according to the invention contain K₂O in a proportion of not more than 4 mol %. K₂O increases the fusibility of the glass and results in an advantageous shift of the UV edge to shorter wavelengths. Its proportion can be at least 0.3 mol % or at least 0.75 mol %. However, an excessively high potassium oxide content leads, due to the radioactive property of its isotope ⁴⁰K, to a glass which is unsuitable for use in photomultipliers. For this reason, the content of this component has to be restricted to not more than 3 mol % or not more than 2 mol %.

In some embodiments, the ratio of the contents of Na₂O to K₂O in mol % is at least 1.5, for example at least 2. In some embodiments, the specified ratio is not more than 4, for example not more than 3. Both oxides serve to improve the fusibility of the glass. However, if too much Na₂O is used, the UV transmission is decreased. Too much K₂O increases the coefficient of thermal expansion. It has been found that the ratio indicated achieves the best results, i.e. the UV transmission and the coefficient of thermal expansion are in advantageous ranges.

The proportion of R₂O in the glasses provided according to the invention may be not more than 10 mol %, not more than 8 mol % or not more than 7 mol %. The glasses can contain R₂O in proportions of at least 3.5 mol %, at least 4 mol % or at least 4.5 mol %. Alkali metal oxides increase the fusibility of the glasses but, as described previously, in higher proportions lead to many disadvantages.

The glasses provided according to the invention can contain MgO in a proportion of up to 4 mol % or up to 2 mol %. MgO is advantageous for the fusibility but in high proportions has been found to be problematical in respect of the desired UV transmission and the demixing tendency. Some embodiments are free of MgO.

The glasses provided according to the invention can contain CaO in a proportion of up to 4 mol % or up to 2 mol %. CaO is advantageous for the fusibility but in high proportions has been found to be problematical in respect of the desired UV transmission. Some embodiments are free of CaO or contain only little CaO, e.g. at least 0.1 mol %, at least 0.3 mol % or at least 0.5 mol %.

The glasses provided according to the invention can contain SrO in a proportion of up to 4 mol %, up to 1 mol % or up to 0.5 mol %. SrO is advantageous for the fusibility but in high proportions has been found to be problematical in respect of the desired UV transmission. Some embodiments are free of SrO.

The glasses provided according to the invention can contain BaO in a proportion of up to 4 mol % or up to 2 mol %. BaO leads to an improvement in the hydrolytic resistance. However, an excessively high barium oxide content leads to demixing and thus to instability of the glass. Some embodiments contain BaO in proportions of at least 0.1 mol %, at least 0.3 mol % or at least 0.8 mol %.

It has been found that the alkaline earth metal oxides RO have a large influence on the demixing tendency. In some embodiments, particular attention is therefore paid to the contents of these components and their ratio to one another. Thus, the ratio of BaO in mol % to the sum of the contents of MgO, SrO and CaO in mol % should be at least 0.4. This value may be at least 0.55, at least 0.7 or at least 1.0. In some embodiments, the value is at least 1.5 or even at least 2. BaO may bring the most advantages in respect of demixing and hydrolytic resistance compared to the other alkaline earth metal oxides. Nevertheless, the specified ratio should not exceed a value of 4.0 or of 3.0. In some embodiments, the glass comprises at least small amounts of CaO and BaO and is free of MgO and SrO.

Advantageous properties may be obtained particularly when the ratio of the proportion of CaO in the glass to BaO, in each case in mol %, is less than 2.0. In particular, this ratio should be less than 1.5 or less than 1.0. Some ratios are even lower, in particular less than 0.8 or less than 0.6. In some embodiments, this ratio is at least 0.3.

In some embodiments, the glass has a molar ratio of B₂O₃ to BaO of at least 8 and not more than 20. The ratio may be at least 10 or at least 11. In some embodiments, the specified ratio is restricted to not more than 18, not more than 16, not more than 15 or not more than 13. In particular, the ratio is at least 10 and not more than 15, or at least 11 and not more than 13. Glasses having the specified ratio of proportions display good properties in respect of the hydrolytic resistance and the demixing factor and also an only small induced extinction.

The proportion of RO in the glasses provided according to the invention can be at least 0.3 mol %. Alkaline earth metal oxides are advantageous for the fusibility but in large proportions have been found to be problematical in respect of the desired UV transmission. In some embodiments, the glass contains not more than 3 mol % of RO.

The sum of the contents in mol % of the alkaline earth metal oxides and alkali metal oxides, RO+R₂O, can be limited to not more than 10 mol %. Some embodiments can contain these components in amounts of not more than 9 mol %. The content of these oxides may be at least 4 mol %, at least 5 mol % or at least 6 mol %. These components increase the demixing tendency and in excessively enlarged proportions reduce the hydrolytic resistance of the glasses.

The ratio of the contents in mol % of B₂O₃ to the sum of the contents of R₂O and RO in mol % can be at least 1.3, at least 1.5 or at least 1.8. The ratio can be limited to a maximum of 6, a maximum of 4.5 or a maximum of 3. In the event of demixing of the glass, alkali metal borates or alkaline earth metal borates can be formed when too much alkali metal oxide or alkaline earth metal oxide relative to B₂O₃ is present. It has been found to be advantageous to set the ratio indicated.

For the melting properties, including T_{g} and T₄, to be in the desired range, it can be advantageous to set the ratio of the content of B₂O₃ to the sum of the contents of SiO₂ and Al₂O₃ in mol % within a narrow range. In some embodiments, this ratio is at least 0.15 and/or not more than 0.4.

The ratio of the proportions in mol % of the sum of the alkali metal oxides R₂O to the sum of the alkaline earth metal oxides RO may be >1, in particular >1.1 or >2. In some embodiments, this ratio is not more than 10, not more than 7 or not more than 5.

The glasses provided according to the invention can contain F⁻ in an amount of from 0 to 6 mol %. The content of F⁻ may be not more than 4 mol %. In some embodiments, at least 1 mol % or at least 2 mol % of this component is used. The component F⁻ improves the fusibility of the glass and influences the UV edge in the direction of shorter wavelengths.

The glasses provided according to the invention can comprise Cl⁻ in an amount of less than 1 mol %, for example less than 0.5 mol % or less than 0.3 mol %. Suitable lower limits are 0.01 mol % or 0.05 mol %.

When it is stated in the present description that the glass is free of a component or does not contain a particular component, it is meant by this that this component may be present at most as impurity. This means that it is not added in significant amounts. According to the invention, “not significant amounts” are, unless indicated otherwise for the component concerned, amounts of less than 500 ppm, for example less than 250 ppm and at least 50 ppm. In some embodiments, “not significant amounts” are, according to the invention, amounts of less than 0.5 ppm, for example less than 0.125 ppm or less than 0.05 ppm.

In the present description, “ppm” are proportions by mass.

Iron contents are for the purposes of the present description expressed as proportions by weight of Fe₂O₃ in ppm. This value can be determined in a manner with which a person skilled in the art will be familiar by determining the amounts of all iron species present in the glass and, for the calculation of the proportion by mass, assuming that all iron is present as Fe₂O₃. Thus, if 1 mmol of iron is found in the glass, the mass assumed for the calculation is 159.70 mg of Fe₂O₃. This procedure takes into account the fact that the amounts of the individual iron species in the glass cannot be determined reliably or can be determined only with great difficulty. In some embodiments, the glass contains less than 100 ppm of Fe₂O₃, in particular less than 50 ppm or less than 10 ppm. In some embodiments having a particularly low iron content, the proportion of Fe₂O₃ is less than 6 ppm, less than 5 ppm or less than 4.5 ppm. The content of Fe₂O₃ is optionally in the range from 0 to 4.4 ppm, from 0 to 4.0 ppm, from 0 to 3.5 ppm, from 0 to 2.0 ppm, from 0 to 1.75 ppm. In some embodiments, the content can be in the range from 0 to 1.5 ppm, or from 0 to 1.25 ppm. In some embodiments, the glass is free of any contamination with Fe₂O₃.

In some embodiments, the glass contains less than 100 ppm of TiO₂, for example less than 50 ppm or less than 10 ppm. In some embodiments having a particularly low TiO₂ content, the glass contains less than 7 ppm, less than 6 ppm, less than 5 ppm or less than 4 ppm. The content of TiO₂ is optionally in the range from 0 to 6.9 ppm, from 0 to 5.8 ppm, from 0 to 4.7 ppm, from 0 to 3.8 ppm or from 0 to 2.5 ppm. In some embodiments, the proportion of this component can be in the range from 0 to 1.5 ppm, from 0 to 1.0 ppm, from 0 to 0.75 ppm, from 0 to 0.5 ppm and from 0 to 0.25 ppm. In some embodiments, the glass is free of any contamination with TiO₂.

In some embodiments, the glass comprises less than 100 ppm of arsenic, for example less than 50 ppm or less than 10 ppm. Preference may be given to a glass which comprises less than 100 ppm of antimony, less than 50 ppm of antimony or less than 10 ppm of antimony. Arsenic and antimony are toxic and hazardous to the environment; in addition they both increase the solarization of the glass.

If it is indicated in this description with reference to a chemical element (e.g. As, Sb) that this component is not present, this statement applies, unless indicated otherwise in the particular case, to any chemical form. For example, the statement that the glass has an As content of less than 100 ppm means that the sum of the proportions by mass of the As species present (e.g. As₂O₃, As₂O₅, etc.) together does not exceed the value of 100 ppm.

In some embodiments, the borosilicate glass comprises the following components (in mol % on an oxide basis):

| Component | Content (mol %) |
|---|---|
| SiO₂ | 68-73 |
| Al₂O₃ | 2-5 |
| B₂O₃ | 12-18 |
| Na₂O | 1-4 |
| K₂O | 0-2 |
| CaO | >20-2 |
| SrO | 0-1 |
| BaO | 0-4 |
| F⁻ | 0-6 |

In some embodiments, the glass comprises the following components in mol %:

| Component | Content (mol %) |
|---|---|
| SiO₂ | 68-73 |
| Al₂O₃ | 3-5 |
| B₂O₃ | 12-18 |
| Li₂O | 0-2.8 |
| Na₂O | 1-4 |
| K₂O | 0-2 |
| CaO | >0-2 |
| SrO | 0-1 |
| BaO | >0-4 |
| F⁻ | 0-6 |

In some embodiments, the borosilicate glass has a refractive index n_{d} of from 1.45 to 1.55. The refractive index can be less than 1.50.

The glass displays an excellent hydrolytic resistance. In particular, the glass has a hydrolytic class in accordance with ISO 719:1989-12 of HGB3 or better, in particular HGB2 or HGB1.

In some embodiments, the glass has a demixing factor in respect of its hydrolytic resistance in the range from 0.35 to 1.65, for example from 0.5 to 1.10. For example, the factor is at least 0.65. This factor may be close to 1.00, which corresponds to the case of unchanged hydrolytic resistance after demixing. In some embodiments, the demixing factor is a maximum of 1.40, a maximum of 1.25 or a maximum of 1.10. The demixing factor is a measure of the tendency of the hydrolytic resistance in accordance with ISO 719 of the glass to change as a result of demixing. Demixing occurs on fusion of the glasses owing to the temperature influence. It has been found to be advantageous to select glasses having a demixing factor of very close to 1, so that a glass which has properties in respect of its hydrolytic resistance which differ greatly from the raw glass is not obtained by fusion. The demixing factor is influenced by the composition of the glass, but also by its thermal history (cool state). The demixing factor can be set via the cooling rate of the glass in the production process.

The coefficient of thermal expansion of the glasses may be less than 4.5 ppm/K. It can be in a range from 3.5 to <5 ppm/K, for example from 3.75 to 4.75 ppm/K, from 4.1 to 4.6 ppm/K or from 4.1 to <4.5 ppm/K.

The glass transition temperature T_{g} may be below 500° C. It can be in a range from 400° C. to 550° C., for example from 430° C. to 500° C. or in a range from 450° C. to 480° C.

The processing temperature T₄ of the glasses provided according to the invention may be below 1200° C., such as below 1125° C. It can be in a range from 1000° C. to 1200° C., such as in a range from 1025° C. to 1175° C.

The glasses provided according to the invention may have a product CTE [° C.⁻¹]×T₄ [° C.] of not more than 0.0055, for example not more than 0.0053 or not more than 0.0051. The product can be at least 0.0044 or at least 0.0045. It has been found that these glasses display advantageous properties in respect of fusion stress and melting behaviour.

The invention also provides for the use of the glass article of the invention as UV-transparent material. The glass article of the invention may be used in pane, plate, ingot, powder, tube or rod form. In the case of tubes and rods, the glass articles can serve, for example, for further processing to produce containers, windows and the like. However, various other shapes such as sheet glasses or glass blocks and the like can be produced from the glass provided according to the invention. Sheet glasses can, for example, be produced by the float process. Tubes and rods can, for example, be round, oval, flat or be produced in a variety of shapes by subsequent shaping, even as early as during the drawing process. Round rods can, for example, be provided with an external diameter of from about 4 to 17 mm, for example from about 4 to 12 mm or from about 5 to 10 mm. Tube glasses can also be produced by the Vello or A-draw process. Glass tubes are, for example, produced with an external diameter of at least 3 mm, for example at least 5 mm and an upper limit of not more than 35 mm, such as not more than 31 mm. Exemplary tube diameters are in the range from about 10 mm to 29 mm.

It has been found that such tubes can have a wall thickness of at least 0.4 mm, such as at least 0.5 mm or at least 0.6 mm. Maximum wall thicknesses are optionally not more than 1.1 mm, such as wall thicknesses of not more than 0.9 mm or 0.8 mm.

In some embodiments, the glass article is a glass powder. The glass powder can be used as glass flux for enamel coatings with or without pigments. Glass articles provided according to the invention also include sintered shaped bodies which are produced by pressing and firing or slip casting and firing. The glass article can be provided in the form of UV-transparent layers or shaped bodies.

Glass articles provided according to the invention may be used for or as UV-LEDs, UV-transparent lamps, protective tubes for UV-lamps, UV-transparent material for UV oxidation reactors, UV flame detectors, UV photocells, solar reactors, spectral analysis instruments, photomultipliers and for windows (in particular EPROM windows), covering plates for solar cells (e.g. in space), UV-transparent cells (e.g. for photoluminescence measurements with UV excitation), UV-CCLs (cold cathode lamps) and/or xenon flash lamps.

In some embodiments, the glass articles are used in diagnostics, for example as microfluidics component, e.g. for photoluminescence-based diagnostic methods. Here, at least either the bottom plate or the cover plate can consist of the glass having increased UV transmission. The higher UV transmission improves the signal-to-noise ratio of the diagnostic method.

The glass articles may be used for lamps which emit a particularly high proportion of UV radiation, in particular UV lamps with and without a protective tube.

The glass article can be produced by drawing processes known per se for glass tubes and rods. Depending on the desired shape, a person skilled in the art will choose a suitable production process, e.g. ingot casting for ingots and floats or down draw for panes. The cooling of the glass in the process may be set so that the desired hypothetical temperature is achieved.

In some embodiments, the glass article is produced using the Vello process. In the Vello process, the glass melt flows vertically downward (in the direction of gravity) through a shaping tool formed by an outflow ring and a needle. The shaping tool forms a negative (die) of the cross section of the glass tube or glass rod produced. In the production of glass tubes, a needle is arranged as a shaping part in the center of the shaping tool.

The difference between the Vello process and the A-draw process is firstly that in the Vello process the glass melt is diverted to the horizontal direction after exit from the shaping tool and secondly that the needle in the Vello process has a passage through which the blowing air flows. The blowing air ensures, as in the case of the Danner process, that the glass tube formed does not collapse. In the A-draw process, the solidified glass melt is parted off without prior deflection. Since no deflection occurs, the use of blowing air can also be dispensed with in production of the tube.

In some embodiments, the glass article has at least one polished surface. Optionally, the glass article has at least one chamfered edge. The polished surface may have a surface roughness Ra of less than 10 nm or less than 5 nm. Chamfered edges are more impact resistant, in particular more resistant to chipping than non-chamfered edges.

Thermal and/or Chemical Tempering

Optionally, the manufacturing process comprises the step of chemical and/or thermal tempering of the glass article. The “tempering” is also referred to as “hardening” or “toughening”.

In some embodiments, the glass article is toughened on at least one surface, in particular thermally and/or chemically toughened. For example, it is possible to chemically temper glass articles by ion exchange. In this process, small alkali ions in the article are usually replaced by larger alkali ions. Often, the smaller sodium is replaced by potassium. However, it is also possible that the very small lithium is replaced by sodium and/or potassium. Optionally, it is possible that alkali ions are replaced by silver ions. Another possibility is that alkaline earth ions are exchanged for each other according to the same principle as the alkali ions. In some embodiments, the ion exchange takes place in a bath of molten salt between the article surface and the salt bath. Such a bath is also referred to as “toughening bath”. Pure molten salt, for example molten KNO₃, can be used for the exchange. However, salt mixtures or mixtures of salts with other components can also be used. The mechanical resistance of an article can further be increased if a selectively adjusted compressive stress profile is built up within the article. This can be achieved by mono- or multistage ion exchange processes.

By replacing small ions with large ions or by thermal tempering, a compressive stress is created in the corresponding zone, which drops from the surface of the glass article towards the center. The maximum compressive stress is just below the glass surface and is also referred to as CS (compressive stress). CS is a stress and is expressed in units of MPa. The depth of the compressive stress layer is abbreviated as “DoL” and is given in the unit μm. In some embodiments, CS and DoL are measured using the FSM-60LE apparatus from Orihara.

In some embodiments, CS is greater than 100 MPa. In some embodiments, CS is at least 200 MPa, at least 250 MPa, or at least 300 MPa. In some embodiments, CS is at most 1,000 MPa, at most 800 MPa, at most 600 MPa, or at most 500 MPa. In some embodiments, CS is in a range from >100 MPa to 1,000 MPa, from 200 MPa to 800 MPa, from 250 MPa to 600 MPa, or from 300 MPa to 500 MPa.

In some embodiments, the glass article is thermally toughened. Thermal toughening is typically achieved by rapid cooling of the hot glass surface. Thermal toughening has the advantage that the compressive stress layer can be formed deeper (larger DoL) than with chemical toughening. This makes the glasses less susceptible to scratching, since the compressive stress layer cannot be penetrated as easily with a scratch as with a thinner compressive stress layer.

The glasses or glass articles can, for example, be subjected to a thermal tempering process after a melting, shaping, annealing/cooling process and cold post-processing steps. In this process, glass bodies (e.g. a previously described glass article or a preliminary product), for example flat glass, may be fed horizontally or suspended into a device and rapidly heated to a temperature up to a maximum of 150° C. above the transformation temperature T_{G}. The surfaces of the glass body are then rapidly cooled, for example, by blowing cold air through a nozzle system. As a result of the rapid cooling of the glass surfaces, they are frozen in an expanded network, while the interior of the glass body cools slowly and has time to contract more. This creates a compressive stress in the surface layer and a tensile stress in the interior. The amount of compressive stress depends on various glass parameters such as CTE_{glass} (average linear coefficient of thermal expansion below Tg), CTE_{liquid} (average linear coefficient of thermal expansion above Tg), strain point, softening point, Young's modulus and also on the amount of heat transfer between the cooling medium and the glass surface as well as the thickness of the glass bodies.

In some embodiments, a compressive stress of at least 50 MPa is generated. As a result, the flexural strength of the glass bodies can be doubled to tripled compared to non-toughened glass. In some embodiments, the glass is heated to a temperature of 750 to 800° C. and tempered fast in a stream of cold air. Optionally, the blowing pressure may be from 1 to 16 kPa. With the glasses or glass articles described herein, values of compressive stress of 50 to 250 MPa, such as 75 to 200 MPa, for example, are achieved on commercially available systems.

In some embodiments, the glass article has a compressive stress layer with a compressive stress of at least 50 MPa, in particular at least 75 MPa, at least 85 MPa or at least 100 MPa. The glass article may have a compressive stress layer on one, two or all of its surfaces. The compressive stress of the compressive stress layer may be limited to at most 250 MPa, at most 200 MPa, at most 160 MPa or at most 140 MPa. These compressive stress values may be present, in particular, in thermally toughened glass articles.

In some embodiments, the depth of the compressive stress layer of the glass article is at least 10 μm, at least 20 μm, at least 30 μm, or at least 50 μm. In some embodiments, this layer may even be at least 80 μm, at least 100 μm, or at least 150 μm. Optionally, the DoL is limited to at most 2,000 μm, at most 1,500 μm, at most 1,250 μm, or at most 1,000 μm. For example, the DoL can be from 10 μm to 2,000 μm, from 20 μm to 1,500 μm, or from 30 μm to 1,250 μm. In some embodiments, the glass article is thermally toughened with a DoL of at least 300 μm, at least 400 μm or at least 500 μm. Optionally, the DoL may be at most 2,000 μm, at most 1,500 μm, or at most 1,250 μm. In some embodiments, the DoL is from 300 μm to 2,000 μm, from 400 μm to 1,500 μm, or from 500 μm to 1,250 μm.

### Embodiments

The invention relates to a glass that is resistant in several respects. Particularly resistant glass is especially useful where the glass is exposed to special requirements. This is the case, for example, in extreme environments. Extreme environments are in particular areas of application in which special resistance, durability and safety are required, e.g. areas requiring explosion protection.

In some embodiments, the invention relates to a glass article with special suitability for use in extreme environments and with the following properties:
an induced extinction α(λ) at 200 nm of not more than 0.300 after 48 hours irradiation with a deuterium lamp,
an induced extinction α(λ) at 254 nm of not more than 0.100 after 48 hours irradiation with a deuterium lamp,
a thickness of at least 0.3 mm, such as at least 3 mm and/or up to 20 mm, and/or
a thermal shrinkage of less than 50 μm/100 mm.

In extreme environments, it may be useful to provide a certain minimum thickness for the glass article, since thicker glasses are mechanically more stable than thinner glasses. However, thicker glass absorbs a greater portion of the UV radiation entering the glass, resulting in the generation of heat. In environments with highly flammable materials, high heat generation can be problematic. A glass article with low induced extinction at 200 nm and/or 254 nm offers the advantage that transmission remains high for the wavelengths under consideration, even after extended use, and extreme heat generation is avoided.

According to the invention, the glass article can also be used in a UV lamp for disinfecting surfaces in extreme environments. In some embodiments, the glass article is used in a UV lamp (particularly as a cover) that is used to disinfect a site of action. The site of action may be an object that is touched by many people, for example a handle, in particular a door handle. The UV lamp can, for example, be aligned in such a way that it applies UV radiation to the site of action. In this case, a certain proximity to the site of action cannot be avoided. Accordingly, there is a risk here that the glass article will be damaged by impacts. This results in a need for mechanical resistance. The mechanical resistance can be improved by a large thickness of the glass article, which, however, reduces the transmission of the article and greatly increases the heating of the glass during operation of the UV lamp. Excessive heating should be avoided, which in turn is positively influenced by very good transmission and low induced extinction. Excessively high temperatures impair safety due to the risk of user burns or explosions. In principle, the risk of burns can be reduced by greater distance, but this must be compensated with greater radiation intensity with the disadvantage again of stronger heat generation.

The invention also relates to a UV lamp and the use of the glass article in a UV lamp for disinfection, in particular in extreme environments, in particular for disinfecting sites of action, e.g. those touched by many people. It has proven advantageous to maintain a minimum distance between the surface to be disinfected and the glass article of 5 cm, in particular 7.5 cm or 10 cm. When using the glass article described herein, a power density of at least 1.0 mW/cm², at least 1.5 mW/cm², at least 2.5 mW/cm², at least 3.0 mW/cm² or at least 3.5 mW/cm² can be set at the site of action. The site of action is the surface to be disinfected. Optionally, the power density is at most 20 mW/cm², at most 15 mW/cm² or at most 10 mW/cm². In particular, the power density is the power that can be measured at the site of action as UV radiation, in particular UV-C radiation, mediated by the UV lamp. In some embodiments, the site of action is periodically disinfected. This means that the site of action is not irradiated continuously, but only intermittently. For example, an irradiation interval can be triggered by touch, presence or actuation by the user. For example, an irradiation interval may be at least 1 second, at least 5 seconds, at least 10 seconds, or at least 20 seconds. Optionally, an irradiation interval lasts at most 10 minutes, at most 5 minutes, at most 2 minutes, or at most 1 minute.

In some embodiments, the UV lamp and/or the glass article has a heat-optimized structure, wherein the thickness of the glass article and the UV transmission of the glass article are chosen in such a way that when a site of action 70 mm away from the glass article (disposed on the opposite side of the article with respect to the light source) is irradiated with a medium pressure mercury lamp at 120 W/cm and an arc length of 4 cm (e.g. Philips HOK 4/120) at a UVC power density of 17.27 mW/cm² for a duration of 5 seconds at an ambient temperature of 20° C., no temperature at the surface of the glass article facing the site of action exceeds 45° C. In some embodiments, the radiation passes perpendicularly through the glass article, i.e., the light enters the glass article substantially perpendicular to the surface facing the light source and/or the light exits the glass article substantially perpendicular to the surface of the glass article facing the site of action. In particular, no temperature exceeds a value of 42.5° C., 40° C. or 37.5° C. In some embodiments, said temperature limits are not exceeded even after 10 seconds, 20 seconds, 30 seconds, 45 seconds, 60 seconds, 90 seconds, 120 seconds, 150 seconds or 180 seconds of irradiation. The property describes how strongly the glass article heats up when irradiated vertically with commonly used UV light sources. It is achieved that a UV lamp with a lamp cover made of the glass article does not become dangerously hot. UVC power density refers to the power density imparted by radiation in the UVC range (280 to 200 nm). Medium-pressure mercury lamps also emit light at other wavelengths, which are not taken into account here when considering UVC power density. The measurement is performed under ambient atmosphere. For clarification: the described property does not limit the UV lamp or the application of the glass article to medium-pressure mercury lamps.

In some embodiments, the glass article meets the requirements for the fracture pattern according to DIN EN 12150-1:2020-07. A whole article or a part of an article can be examined; in deviation from the specified standard, the article can be smaller than indicated there, as long as the area to be considered is exceeded. The area to be considered for the breakage pattern can be in particular 40 mm×40 mm or 25 mm×25 mm. In some embodiments, the glass article breaks into not less than 25 pieces, in particular not less than 30 pieces or not less than 40 pieces, under the above conditions. It is advantageous for the article to break into many pieces, since in the event of breakage the risk of injury is low if the pieces are small. The fracture pattern can be influenced, for example, by the choice of glass composition, cooling condition (thermal shrinkage), by adjusting stresses in the glass and/or by tempering the article.

In some embodiments, the invention relates to a glass article composed of a glass having
a demixing factor in respect of its hydrolytic resistance in the range from 0.10 to 1.65,
an induced extinction α(λ) at 200 nm of not more than 0.300 after 48 hours irradiation with a deuterium lamp,
an induced extinction α(λ) at 254 nm of not more than 0.100 after 48 hours irradiation with a deuterium lamp,
a thickness of at least 0.3 mm, for example at least 3 mm and/or up to 20 mm, and
a thermal shrinkage of less than 50 μm/100 mm.

In some embodiments, the invention relates to a glass article composed of a glass having
a demixing factor in respect of its hydrolytic resistance in the range from 0.10 to 1.65,
a thickness of at least 0.3 mm, for example at least 3 mm and/or up to 20 mm, and
a compressive stress of at least 50 MPa on at least one surface.

In some embodiments, the invention relates to a glass article composed of a glass having
a demixing factor in respect of its hydrolytic resistance in the range from 0.10 to 1.65,
a thickness of at least 0.3 mm, for example at least 3 mm and/or up to 20 mm, and
a compressive stress of at least 50 MPa on at least one surface and a fracture pattern characterized by breakage of an area section of 40 mm×40 mm into not less than 25 pieces.

### Examples

Tables 1-4 show exemplary glass compositions in mol % and further glass properties.

TABLE 1

| Component | | | | | | |
|---|---|---|---|---|---|---|
| [mol %] | 1 | 2 | 3 | 4 | 5 | 6 |
| SiO₂ | 70.07 | 67.85 | 69.04 | 70.03 | 69.70 | 69.26 |
| Al₂O₃ | 3.27 | 3.22 | 3.48 | 3.48 | 3.42 | 3.47 |
| B₂O₃ | 18.15 | 17.78 | 17.80 | 16.24 | 16.25 | 16.95 |
| Li₂O | 1.55 | 1.55 | 1.48 | 1.68 | 1.67 | 1.49 |
| Na₂O | 2.43 | 2.40 | 2.87 | 2.54 | 2.50 | 2.66 |
| K₂O | 1.02 | 1.01 | 1.22 | 0.95 | 0.94 | 1.03 |
| MgO | | 3.33 | | | | |
| CaO | 0.62 | 0.66 | 0.67 | 0.66 | 1.54 | 0.66 |
| SrO | 0.02 | 0.01 | 0.01 | | | |
| BaO | 0.47 | | 0.50 | 1.40 | 1.07 | 1.28 |
| ZnO | | | | | | |
| F⁻ | 2.27 | 2.07 | 2.75 | 2.81 | 2.70 | 2.97 |
| Cl⁻ | 0.14 | 0.13 | 0.18 | 0.19 | 0.19 | 0.21 |
| Total | 100.00 | 100.00 | 100.00 | 100.00 | 100.00 | 100.00 |
| Σ R₂O | 5.00 | 4.96 | 5.58 | 5.17 | 5.12 | 5.19 |
| Σ RO | 1.09 | 3.99 | 1.17 | 2.07 | 2.62 | 1.96 |
| Σ R₂O + Σ | 6.09 | 8.95 | 6.75 | 7.24 | 7.74 | 7.14 |
| RO | | | | | | |
| B₂O₃/Σ R₂O | 3.63 | 3.58 | 3.19 | 3.14 | 3.18 | 3.27 |
| B₂O₃/Σ RO | 16.59 | 4.46 | 15.21 | 7.83 | 6.21 | 8.67 |
| B₂O₃/BaO | 38.68 | — | 35.34 | 11.63 | 15.21 | 13.23 |
| B₂O₃/(Σ RO + | 2.98 | 1.99 | 2.64 | 2.24 | 2.10 | 2.37 |
| Σ R₂O) | | | | | | |
| B₂O₃/(SiO₂ + | 0.25 | 0.25 | 0.25 | 0.22 | 0.22 | 0.23 |
| Al₂O₃) | | | | | | |
| Σ R₂O/Σ | 4.57 | 1.24 | 4.77 | 2.50 | 1.95 | 2.65 |
| RO | | | | | | |
| Transmission | 63.7 | | 55.5 | 59.7 | | 59.6 |
| @200 nm, | | | | | | |
| d = 1 mm | | | | | | |
| [%] | | | | | | |
| Transmission | 87.4 | | 75.5 | 87.8 | | 84.2 |
| @254 nm, | | | | | | |
| d = 1 mm | | | | | | |
| [%] | | | | | | |
| CTE | 4.14 | — | 4.42 | 4.22 | — | 4.37 |
| [ppm/K] | | | | | | |
| T_{g} [° C.] | 443 | — | 453 | 467 | — | 465 |
| T₄ [° C.] | 1085 | — | 1060 | 1090 | — | 1071 |
| CTE*T₄ | 0.0045 | — | 0.0047 | 0.0046 | — | 0.0047 |

TABLE 2

| Component | | | | | | |
|---|---|---|---|---|---|---|
| [mol %] | 7 | 8 | 9 | 10 | 11 | 12 |
| SiO₂ | 69.00 | 69.85 | 70.27 | 68.80 | 70.27 | 69.94 |
| Al₂O₃ | 3.44 | 3.43 | 3.51 | 3.37 | 3.30 | 4.82 |
| B₂O₃ | 17.44 | 18.06 | 18.25 | 17.05 | 17.83 | 15.86 |
| Li₂O | 1.67 | 1.44 | 1.67 | 1.48 | | 1.62 |
| Na₂O | 2.69 | 2.46 | 2.45 | 3.10 | 3.14 | 2.65 |
| K₂O | 1.05 | 0.97 | 0.97 | 1.69 | 1.76 | 1.26 |
| MgO | | | | | | |
| CaO | 1.12 | | 0.67 | 0.62 | 0.63 | 0.63 |
| SrO | 0.01 | | | | | |
| BaO | 0.65 | 0.49 | | 0.49 | 0.48 | 0.48 |
| ZnO | | 0.62 | | | | |
| F⁻ | 2.75 | 2.53 | 2.13 | 3.17 | 2.45 | 2.61 |
| Cl⁻ | 0.17 | 0.14 | 0.09 | 0.23 | 0.14 | 0.14 |
| Total | 100.00 | 100.00 | 100.00 | 100.00 | 100.00 | 100.00 |
| Σ R₂O | 5.41 | 4.88 | 5.09 | 6.27 | 4.90 | 5.53 |
| Σ RO | 1.78 | 0.49 | 0.67 | 1.12 | 1.11 | 1.11 |
| Σ R₂O + Σ | 7.19 | 5.37 | 5.76 | 7.38 | 6.01 | 6.63 |
| RO | | | | | | |
| B₂O₃/Σ R₂O | 3.22 | 3.70 | 3.58 | 2.72 | 3.64 | 2.87 |
| B₂O₃/Σ RO | 9.78 | 36.89 | 27.39 | 15.29 | 16.06 | 14.30 |
| B₂O₃/BaO | 26.67 | 36.89 | — | 34.48 | 37.08 | 32.85 |
| B₂O₃/(Σ RO + | 2.42 | 3.37 | 3.17 | 2.31 | 2.97 | 2.39 |
| Σ R₂O) | | | | | | |
| B₂O₃/(SiO₂ + | 0.24 | 0.25 | 0.25 | 0.24 | 0.24 | 0.21 |
| Al₂O₃) | | | | | | |
| Σ R₂O/Σ | 3.04 | 9.96 | 7.64 | 5.62 | 4.41 | 4.98 |
| RO | | | | | | |
| Transmission | — | 58.7 | 62.7 | 55.5 | 55.4 | 60.5 |
| @200 nm, | | | | | | |
| d = 1 mm | | | | | | |
| [%] | | | | | | |
| Transmission | — | 86.2 | 84.8 | 76.1 | 84.9 | 87.1 |
| @254 nm, | | | | | | |
| d = 1 mm | | | | | | |
| [%] | | | | | | |
| CTE | — | 4.16 | 4.14 | 4.72 | 4.49 | 4.4 |
| [ppm/K] | | | | | | |
| T_{g} [° C.] | — | 447 | 448 | 453 | 459 | 475 |
| T₄ [° C.] | — | 1094 | 1106 | 1035 | 1117 | 1152 |
| CTE*T₄ | — | 0.0046 | 0.0046 | 0.0049 | 0.0050 | 0.0051 |

TABLE 3

| Component | | | | | | |
|---|---|---|---|---|---|---|
| [mol %] | 13 | 14 | 15 | 16 | 17 | 18 |
| SiO₂ | 70.19 | 69.74 | 70.93 | 70.57 | 70.42 | 69.99 |
| Al₂O₃ | 4.81 | 4.29 | 3.28 | 3.83 | 3.31 | 3.51 |
| B₂O₃ | 15.86 | 16.02 | 16.00 | 14.28 | 15.91 | 16.02 |
| Li₂O | 1.62 | 1.61 | 1.58 | 1.62 | 1.61 | 1.66 |
| Na₂O | 2.43 | 2.41 | 2.35 | 2.39 | 2.43 | 2.51 |
| K₂O | 1.03 | 1.02 | 1.32 | 1.50 | 1.28 | 0.94 |
| MgO | | | | | | |
| CaO | 1.13 | 0.63 | 0.11 | 0.89 | 0.67 | 0.66 |
| SrO | 0.02 | 0.02 | 0.02 | 0.01 | 0.02 | |
| BaO | 0.48 | 1.49 | 1.45 | 1.46 | 1.22 | 1.40 |
| ZnO | | | | | | |
| F⁻ | 2.35 | 2.60 | 2.75 | 3.18 | 2.90 | 3.07 |
| Cl⁻ | 0.11 | 0.17 | 0.21 | 0.27 | 0.23 | 0.23 |
| Total | 100.00 | 100.00 | 100.00 | 100.00 | 100.00 | 100.00 |
| Σ R₂O | 5.07 | 5.04 | 5.25 | 5.51 | 5.32 | 5.11 |
| Σ RO | 1.61 | 2.14 | 1.58 | 2.37 | 1.90 | 2.07 |
| Σ R₂O + Σ | 6.68 | 7.18 | 6.83 | 7.88 | 7.23 | 7.18 |
| RO | | | | | | |
| B₂O₃/Σ R₂O | 3.13 | 3.18 | 3.05 | 2.59 | 2.99 | 3.14 |
| B₂O₃/Σ RO | 9.86 | 7.49 | 10.15 | 6.03 | 8.36 | 7.72 |
| B₂O₃/BaO | 33.13 | 10.77 | 11.04 | 9.75 | 13.04 | 11.46 |
| B₂O₃/(Σ RO + | 2.37 | 2.23 | 2.34 | 1.81 | 2.20 | 2.23 |
| Σ R₂O) | | | | | | |
| B₂O₃/(SiO₂ + | 0.21 | 0.22 | 0.22 | 0.19 | 0.22 | 0.22 |
| Al₂O₃) | | | | | | |
| Σ R₂O/Σ | 3.15 | 2.36 | 3.33 | 2.33 | 2.80 | 2.46 |
| RO | | | | | | |
| Transmission | 60.8 | 60.8 | 43.8 | 10.5 | 30.7 | 50.9 |
| @200 nm, | | | | | | |
| d = 1 mm | | | | | | |
| [%] | | | | | | |
| Transmission | 87.1 | 85.4 | 84.9 | 51.9 | 77.0 | 83.8 |
| @254 nm, | | | | | | |
| d = 1 mm | | | | | | |
| [%] | | | | | | |
| CTE | 4.18 | 4.28 | 4.25 | 4.46 | 4.28 | 4.23 |
| [ppm/K] | | | | | | |
| T_{g} [° C.] | 471 | 470 | 451 | 473 | 463 | 459 |
| T₄ [° C.] | 1164 | 1122 | 1097 | 1109 | 1086 | 1092 |
| CTE*T₄ | 0.0049 | 0.0048 | 0.0047 | 0.0049 | 0.0046 | 0.0046 |

TABLE 4

| Component | | | | | | |
|---|---|---|---|---|---|---|
| [mol %] | 19 | 20 | 21 | 22 | 23 | 24 |
| SiO₂ | 71.33 | 71.88 | 70.92 | 71.20 | 71.85 | 71.01 |
| Al₂O₃ | 4.15 | 3.91 | 4.17 | 3.97 | 4.16 | 3.94 |
| B₂O₃ | 14.37 | 14.21 | 14.15 | 14.24 | 14.17 | 14.60 |
| Li₂O | 1.66 | 1.57 | 1.85 | 1.72 | 1.26 | 1.71 |
| Na₂O | 2.34 | 2.36 | 2.66 | 2.98 | 3.05 | 2.67 |
| K₂O | 1.23 | 1.06 | 1.21 | 1.07 | 1.06 | 1.06 |
| MgO | | | | | | |
| CaO | 0.74 | 0.56 | 0.74 | 0.56 | 0.56 | 0.56 |
| SrO | 0.01 | 0.01 | 0.01 | 0.02 | 0.01 | 0.02 |
| BaO | 1.25 | 1.25 | 1.24 | 1.25 | 1.03 | 1.22 |
| ZnO | | | | | | |
| F⁻ | 2.72 | 3.03 | 2.81 | 2.77 | 2.65 | 2.99 |
| Cl⁻ | 0.20 | 0.16 | 0.23 | 0.23 | 0.19 | 0.23 |
| Total | 100.00 | 100.00 | 100.00 | 100.00 | 100.00 | 100.00 |
| Σ R₂O | 5.23 | 5.00 | 5.72 | 5.76 | 5.37 | 5.43 |
| Σ RO | 2.01 | 1.82 | 2.00 | 1.82 | 1.61 | 1.80 |
| Σ R₂O + Σ | 7.23 | 6.82 | 7.71 | 7.59 | 6.98 | 7.23 |
| RO | | | | | | |
| B₂O₃/Σ R₂O | 2.75 | 2.84 | 2.48 | 2.47 | 2.64 | 2.69 |
| B₂O₃/Σ RO | 7.16 | 7.80 | 7.09 | 7.81 | 8.82 | 8.12 |
| B₂O₃/BaO | 11.48 | 11.37 | 11.37 | 11.41 | 13.72 | 11.93 |
| B₂O₃/(Σ RO + | 1.99 | 2.08 | 1.83 | 1.88 | 2.03 | 2.02 |
| Σ R₂O) | | | | | | |
| B₂O₃/(SiO₂ + | 0.19 | 0.19 | 0.19 | 0.19 | 0.19 | 0.19 |
| Al₂O₃) | | | | | | |
| Σ R₂O/Σ | 2.61 | 2.74 | 2.86 | 3.16 | 3.35 | 3.02 |
| RO | | | | | | |
| Transmission | 64.6 | 62.7 | 54.4 | 63.0 | 64.5 | 61.2 |
| @200 nm, | | | | | | |
| d = 1 mm | | | | | | |
| [%] | | | | | | |
| Transmission | 87.4 | 86.2 | 79.9 | 84.4 | 86.1 | 86.4 |
| @254 nm, | | | | | | |
| d = 1 mm | | | | | | |
| [%] | | | | | | |
| CTE | 4.22 | 4.1 | 4.38 | 4.36 | 4.3 | 4.29 |
| [ppm/K] | | | | | | |
| T_{g} [° C.] | 469 | 468 | 469 | 466 | 466 | 462 |
| T₄ [° C.] | 1121 | 1135 | 1101 | 1099 | 1137 | 1110 |
| CTE*T₄ | 0.0047 | 0.0047 | 0.0048 | 0.0048 | 0.0049 | 0.0048 |

Table 5 below shows the demixing factor for some of the glasses listed here.

TABLE 5

| | 1 | 17 | 20 | 21 | 22 |
|---|---|---|---|---|---|
| B2O3/BaO | 38.68 | 13.04 | 11.37 | 11.37 | 11.41 |
| Demixing factor | 0.4122 | 0.7391 | 1.0625 | 1.0476 | 0.9583 |

Table 6 below shows the solarization resistance (induced extinction) of glasses at 200 nm and 254 nm after irradiation with a deuterium lamp for 48 hours and 96 hours. The transmission was measured at a glass thickness in the range from 0.70 to 0.75 mm.

TABLE 6

| Induced Extinction | 1 | 15 | 19 | 20 | 22 | 24 |
|---|---|---|---|---|---|---|
| 200 nm, 48 h | 0.070 | 0.129 | 0.053 | 0.031 | 0.022 | 0.018 |
| 200 nm, 96 h | 0.154 | 0.180 | 0.095 | 0.031 | 0.030 | 0.038 |
| 254 nm, 48 h | 0.025 | 0.039 | 0.015 | 0.008 | 0.008 | 0.006 |
| 254 nm, 96 h | 0.062 | 0.063 | 0.032 | 0.010 | 0.013 | 0.007 |

Table 7 below shows rounded transmission values of some glasses after irradiation with a deuterium lamp for 48 hours and 96 hours.

TABLE 7

| Transmission [%] | 1 | 18 | 19 | 20 | 22 | 24 |
|---|---|---|---|---|---|---|
| 200 nm, 48 h | 63.5 | 53.7 | 65.8 | 67.4 | 68.5 | 66.4 |
| 200 nm, 96 h | 58.4 | 54.7 | 63.1 | 67.4 | 67.9 | 65.1 |
| 254 nm, 48 h | 85.4 | 82.0 | 87.4 | 86.8 | 87.4 | 86.9 |
| 254 nm, 96 h | 82.3 | 81.8 | 85.9 | 86.6 | 87.0 | 86.8 |

The following Tables 8-9 show the fusion stresses which were obtained after fusion of glass articles with a glass or with a metal alloy (Kovar). The glass had a CTE of 5.0 ppm/K; the metal alloy had a CTE of 5.4 ppm/K.

TABLE 8

| Fusion stress | 1 | 15 | 16 | 17 | 18 | 19 |
|---|---|---|---|---|---|---|
| Glass, 5.0 ppm/K | 124 | 158 | 119 | 153 | 173 | 225 |
| [nm/cm] | | | | | | |
| Kovar, 5.4 ppm/K | −261 | −221 | −177 | −194 | −229 | −342 |
| [nm/cm] | | | | | | |

TABLE 9

| | Fusion stress | | | | |
|---|---|---|---|---|---|
| | 20 | 21 | 22 | 23 | 24 |
| Glass, 5.0 ppm/K | 261 | 109 | 103 | 211 | 146 |
| [nm/cm] | | | | | |
| Kovar, 5.4 ppm/K | −370 | −229 | −224 | −316 | −266 |
| [nm/cm] | | | | | |

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A glass article, composed of a glass having a demixing factor in respect of its hydrolytic resistance in a range from 0.10 to 1.65.

2. The glass article of claim 1, having an induced extinction α(λ) of not more than 0.300 at 200 nm after irradiation with a deuterium lamp for at least one of 48 hours or 96 hours.

3. The glass article of claim 1, wherein the glass has a molar ratio of B₂O₃ to BaO of at least 8 and not more than 20.

4. The glass article of claim 3, wherein the molar ratio of B₂O₃ to BaO is at least 10 and not more than 15.

5. The glass article of claim 1, wherein the glass has a hydrolytic class in accordance with ISO 719:1989-12 of HGB3, HGB2 or HGB1.

6. The glass article of claim 1, wherein the glass article has a fusion stress with at least one of:
a metal or a metal alloy having a coefficient of thermal expansion of 5.4 ppm/K in a range from −400 to −130 nm/cm; or
a glass having a coefficient of thermal expansion of 5.0 ppm/K in a range from >0 to 300 nm/cm.

7. The glass article of claim 1, wherein at least one of the following is satisfied:
the glass article has a transmission of at least one of at least 70% at 254 nm measured at a specimen thickness of 1 mm or at least 40% at 200 nm measured at a specimen thickness of 1 mm;
the glass has a ratio of a transmission at 254 nm to a transmission at 200 nm, in each case measured at the specimen thickness of 1 mm, of at least 1.00 and not more than 2.00;
the glass article has a thickness of at least 5 mm; or
the glass article has a thickness of up to 20 mm.

8. The glass article of claim 1, wherein at least one of the following is satisfied:
the glass has a ratio of a proportion of CaO in the glass to BaO, in each case in mol %, of less than 2.0; or
a ratio of a sum of contents (in mol %) of B₂O₃, R₂O and RO to a sum of contents (in mol %) of SiO₂ and Al₂O₃ is from 0.1 to 0.4.

9. The glass article of claim 1, wherein the glass comprises the following components (in mol % on an oxide basis):

| Component | Content (mol %) |
|---|---|
| SiO₂ | 68-73 |
| Al₂O₃ | 2-5 |
| B₂O₃ | 12-18 |
| Na₂O | 1-4 |
| K₂O | 0-2 |
| CaO | >0-2 |
| SrO | 0-1 |
| BaO | >0-4 |
| F⁻ | 0-6 |

10. The glass article of claim 1, wherein the glass comprises the following components (in mol % on an oxide basis):

| Component | Content (mol %) |
|---|---|
| SiO₂ | 68-73 |
| Al₂O₃ | 3-5 |
| B₂O₃ | 12-18 |
| Li₂O | 0-2.8 |
| Na₂O | 1-4 |
| K₂O | 0-2 |
| CaO | >0-2 |
| SrO | 0-1 |
| BaO | >0-4 |
| F⁻ | 0-6 |

11. The glass article of claim 1, wherein the glass has at least one of:
a coefficient of thermal expansion in a range from 3.5 to <5 ppm/K; or
a product CTE [° C.⁻¹]×T₄ [° C.] of not more than 0.0055, wherein CTE is a coefficient of thermal expansion of the glass and T₄ is the temperature at which the glass has a viscosity of 10⁴ dPa s.

12. The glass article of claim 1, having an induced extinction of not more than 0.100 at 254 nm after irradiation with a deuterium lamp for at least one of 48 hours or 96 hours.

13. The glass article of claim 1, wherein the glass at least one of:
has a proportion of R₂O of not more than 10 mol %;
has a demixing factor in respect of its hydrolytic resistance of at least 0.35;
comprises alkaline earth metal oxides and alkali metal oxides, RO+R₂O, in a total amount of not more than 10 mol %;
has a ratio of BaO in mol % to a sum of contents of MgO, SrO and CaO in mol % that is at least 0.4;
contains F⁻ in an amount of at least 1 mol %; or
has a ratio of a content of Na₂O to K₂O in mol % of at least 1.5.

14. The glass article of claim 1, wherein at least one surface of the glass article is thermally toughened or chemically toughened with at least one of a compressive stress of at least 50 MPa or a depth of a compressive stress layer of at least 10 μm.

15. The glass article of claim 1, having a fracture pattern characterized by breakage of an area section of 40 mm×40 mm into not less than 25 pieces, determined according to DIN EN 12150-1.

16. The glass article of claim 1, wherein the glass article is a rod, an ingot, powder, a pane, a plate or a tube.

17. An ultraviolet (UV) lamp for disinfection of a site of action, comprising:
a glass article composed of a glass having a demixing factor in respect of its hydrolytic resistance in a range from 0.10 to 1.65.

18. The UV lamp of claim 17, wherein at least one of the following is satisfied:
a distance between a surface to be disinfected and the glass article is at least 5 cm;
a power density at the site of action is at least 2.5 mW/cm²;
a power density at the site of action is at most 20 mW/cm²;
an irradiation interval of the UV lamp is at least 1 second; or
an irradiation interval of the UV lamp is at most 10 minutes.

19. The UV lamp of claim 17, wherein a thickness of the glass article and a UV transmission of the glass article are matched to one another in such a way that when a site of action 70 mm away from the glass article, and disposed on an opposite side of the glass article with respect to a light source, is irradiated with a medium pressure mercury lamp at 120 W/cm and an arc length of 4 cm at a UVC power density of 17.27 mW/cm² at the site of action for a duration of 5 seconds at an ambient temperature of 20° C., wherein no temperature at a surface of the glass article facing the site of action exceeds 45° C.
